(19) United States
(12) Patent Application Publication
(10) Pub. No.: US 2010/0271308 A1
(43) Pub. Date: Oct. 28, 2010

(54) SIMPLIFIED INTERFACE FOR A COMPUTER

(76) Inventor: Rachel Van Buren, Ramat Gan (IL)

Correspondence Address: ROBERT G. LEV, 4766 MICHIGAN BLVD., YOUNGSTOWN, OH, 44505, US

(21) Appl. No.: 12/733,383

(22) PCT Filed: Aug. 29, 2007
(86) PCT No.: PCT/IL07/01069

§ 371 Date: Feb. 25, 2010

(30) Foreign Application Priority Data
Aug. 30, 2006 (IL) 177791

(51) Int. Cl. G06F 3/02

(52) U.S. Cl. 345/168

(57) ABSTRACT

An interface (10) for retrofitting to a keyboard (12), the interface for covering the keyboard and having a plurality of jumbo buttons (14, 16, 18, 20), each jumbo button for covering more than one key of the keyboard, and an associated software program for associating all keys under each jumbo button and optionally disabling keys not under jumbo buttons.

### FIELD OF THE INVENTION

The present invention is directed to providing a device and method for inputting data into a computer that is particularly appropriate for use by users with poor coordination, such as young children, the arthritic elderly and the handicapped, for example.

### BACKGROUND OF THE INVENTION

The home computer is a general purpose device that serves different family members in different ways. Young children can learn shapes, colors, counting and other basic skills, and there is a plethora of computer applications and specially designed interfaces for this market segment.

The severely physically handicapped can interact with the outside world via the computer. By depressing keys using a probe attached to the head, quadriplegics have managed to write poetry and type up their autobiographies.

Now the standard QWERTY array has about 50 keys. Computer keyboards include the QWERTY keypad, an alphanumeric keypad, cursor control keys, editing keys such as INSERT, DELETE, ALT, TAB, navigational keys such as page up, page down, print screen and various function keys. Generally, computer keyboards have over a hundred keys. Such a large number of keys is distracting and confusing to both children and the handicapped.

Special keyboards designed for children are known. Such keyboards tend to have a small number of large, easily depressed keys. They may be connected to the computer instead of to the standard keyboard, or may plug in to one or other of the peripheral ports, such as in place of the printer, for example. However, any keyboard that is connected and disconnected from a computer by plugging it into a computer port and removing it therefrom regularly, tends to have a short life expectancy. Pins get bent, particularly when a child takes the initiative to plug his/her keyboard in. Any peripheral designed for children will tend to be regarded as being a toy. Electronic equipment and children are not really compatible. Food and drink ruin keyboards. In short, special children's keyboards have had limited success.

Another approach is described in Canadian Patent No. 2,194,317 to Fisher Price™ which describes a computer keyboard to aid child users, that sits on a regular keyboard. The Fisher Price™ keyboard covers and blocks out individual blocks of keys, such as the numeric keypad or the function keys to display a reduced selection of keys to the child. However, the buttons to be depressed by child are regular sized keys for adult users.

Blocking out keys or blocks of keys is not new. U.S. Pat. No. 5,348,405 entitled “Computer keyboard key depression inhibitor device” describes a key depression inhibitor device for a computer keyboard which is intended to prevent accidental or inadvertent manual depression of a certain key or combination of keys on a computer keyboard. The device has top, side and end walls which form a generally hollow cover adapted to fit over a single key or over certain combinations of keys in the “F” key section, the page control key section and/or the cursor control key section of a computer keyboard. The device is constructed to fit snugly over the key or combination of keys which it is intended to cover and to be readily removable therefrom, so that it can be installed and removed at will.

U.S. Pat. No. 5,193,924 to Larson, entitled “Cap cover for keyboard keys” describes a cap cover for keyboard keys for use with a computer or cash register. The capcover is essentially a hollow box adapted to rest on base or grid plate. The cap cover prevents keys that are covered thereby from being depressed.

WO 9400809 entitled “Keyboard Cover”, describes a keyboard cover which allows the keys of a keyboard to be used. The cover includes portions which correspond to the faces of the keys. Inserts are attachable to the portions so as to cover markings on the faces of the keys. The inserts are adapted to include markings which are a substitute for the markings on the faces. Alternatively, the portions themselves may include markings which cover and are a substitute for the markings on the faces of the keys.

There are a number of patents that cover the keys of a regular keyboard with keys that are tactile for Braille readers, e.g. U.S. Pat. No. 5,536,170, or which provide lower case letters instead of upper case letters, or which change the alphabets shown on keys to enable use of the keyboard for typing in a different language.

Published US application number US2001/004108 to Lebeau describes disposable plastic covers for keyboards for use in laboratories and the like. These will protect the keys, and allow each key to be individually depressible.

Published US application number US2003/0206153A1 entitled “Keycap for displaying a plurality of indicia” relates to a key cap for use with the keyboard of a computer. The key cap has a support structure which is larger in size than the activation keys and is adapted to display indicia read by the individual. The keycap is used to display a plurality of indicia, such as Braille, pictures, etc., for use with a keyboard that interacts with an electronic device, such as a computer. The keycap includes at least one engagement member, for removably engaging with at least one activation key on a keyboard, and at least a first support structure for displaying the indicia. The first support structure is larger in at least one direction than the activation key and allows the keycap to display the indicia in a sufficiently large size to allow the keycap to display, for example, phrases, sentences, musical notation, mathematical expressions, etc. This feature allows the keycap to be compatible with a large number of software programs used to teach, for example, disabled individuals. The keycap preferably is used with a removable overlay containing the plurality of indicia that allows the keycap to be easily configured to the user's needs or the requirements of the software program. The keycap includes at least one attachment member to removably attach the overlay to the keycap. The attachment member preferably comprises two channels disposed on opposite ends of the first support structure and a second support structure which is adapted to slidably engage with the two channels to hold the overlay immobile between the first and second support structures.

U.S. Pat. No. 6,310,608 to Kaply et al. entitled “System and method of keyboard configuration for disabled user access” relates to a computer system for disabled users and groups keys into a compound key corresponding to a specified command. Essentially a system and method for grouping together multiple keys on a keyboard to form compound keys is presented. An exemplary configuration of compound keys described therein involves grouping function keys “F1” through “F4” together to form one key, grouping function keys “F5” through “F8” to form a second key, and grouping function keys “F9” through “F12” to form a third key. In such an embodiment, actuating any of the keys “F1” through “F4” results in the same input to, the operating system or application program. A compound key may be assigned to a response such as “yes”, “enter”, or “cancel”. In another embodiment, a group of keys could be assigned to a particular alphanumeric character. The alphanumeric keys could in this way be grouped into a reduced number of larger alphanumeric compound keys. A separate group of keys (e.g., the numeric keypad) may be used to toggle between different arrangements of these compound keys, so that all characters may be accessed. A representation of the keyboard illustrating the key groupings active at a particular time and the input corresponding to each grouping may be displayed on the computer's display screen. Alternatively, a template laid over the keyboard may be used to indicate the compound key groupings, particularly for applications in which the grouping does not change during the performance of a task. Although a number of the keys of the keyboard are programmed to input the same signal, the user is still presented with a bewildering array of small keys.

Despite the prior art, there is still a need for a simplified interface that is particularly suitable for the young child, and the present invention addresses this need.

### SUMMARY OF THE INVENTION

It is an aim of the embodiments to provide an interface for a child, to enable the child to interact with a computer.

It is a further aim, that the interface protects the keyboard of the computer.

It is yet a further aim, that the interface is a simple mechanical device that is rugged.

It is still yet a further aim, that the interface may be retrofitted to an existing keyboard.

It is yet a further aim, that the interface is simplified, having a minimum number of keys.

In a first aspect, the present invention is directed to providing an interface for retrofitting to a computer keyboard, the interface having a plurality of jumbo buttons, each jumbo button for covering more than one key of the keyboard.

Typically, the keyboard is a QWERTY keyboard.

Preferably the plurality of jumbo buttons are brightly colored.

Optionally and preferably the plurality of jumbo buttons is marked with easily recognized symbols.

Optionally the easily recognized symbols are selected from the list of letters, numbers, shapes and icons.

In one embodiment substantially vertical push levers are coupled to the jumbo buttons for registering keystrokes on the keys under the jumbo buttons by pushing or pulling the vertical push levers.

Such substantially vertical push levers may be transparent and may be aligned in front of a display so that user activates said vertical push levers when responding to display.

Typically the display is displayed on a monitor coupled to the computer.

In a second embodiment, the interface is a cover that covers the keyboard, grouping at least a first plurality of keys into at least one jumbo button such that pressure on any of said plurality of keys has an equivalent effect.

In one embodiment, the cover prevents pressure from being applied to one or more keys of the keyboard, preventing the one or more keys from being depressed.

Alternatively, keys not associated with the at least one jumbo button are disabled by a software program, such that pressure thereon is not registered by the computer.

In a second aspect, the present invention is directed to providing a program for programming a QWERTY keyboard such that the more than one key of the QWERTY keyboard covered by a specific jumbo button of the interface are programmed in parallel so that any of the keys, covered by the jumbo button will provide an identical signal to the computer.

Optionally keys of keyboard not covered by jumbo-buttons are disabled by the software program, such that pressure thereon has no effect on computer.

Typically the software program defines a low sensitivity to key strokes, such that only conscious thumping of a jumbo button on the interface will register an input and only one single input is registered per thump.

In a third aspect the present invention is directed to a system for converting a standard QWERTY keyboard into a large button simplified keyboard by providing a software program and an interface as described hereinabove.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic exploded isometric projection of the interface according to a first embodiment of the present invention fitted onto a standard computer keyboard;

FIG. 2 is a schematic cross section (side view) of the interface of FIG. 1 fitted to the keyboard;

FIG. 3 is a plan view of the interface of FIG. 1 fitted to the keyboard;

FIG. 4 is a schematic exploded isometric projection of the interface according to a second embodiment of the present invention fitted onto a standard computer keyboard;

FIG. 5 is a schematic cross section (side view) of the interface of FIG. 4 fitted to the keyboard, and

FIG. 6 is a plan view of the interface of FIG. 4 fitted to the keyboard.

### DETAILED DESCRIPTION OF THE EMBODIMENTS

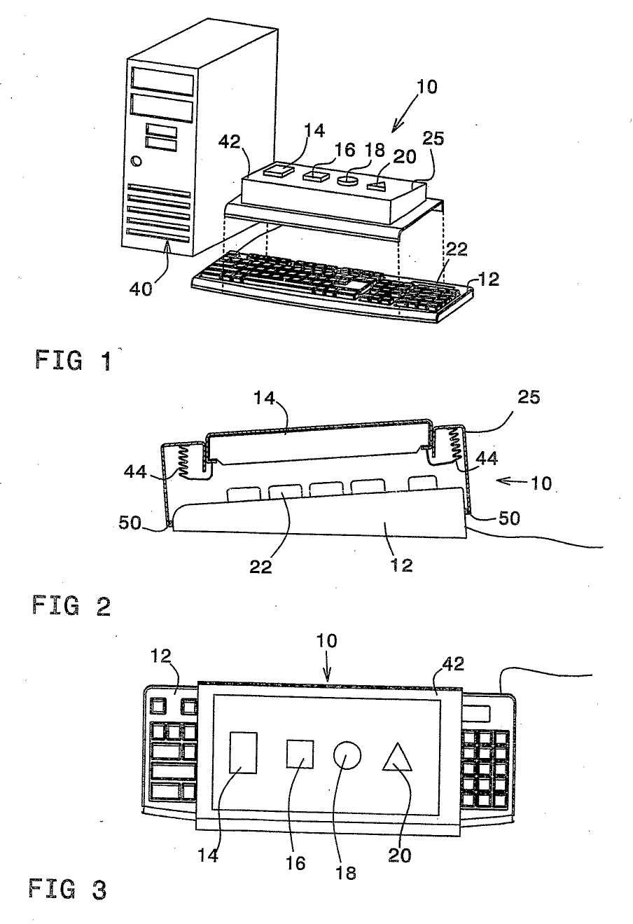

Referring now to FIGS. 1 to 3, an interface 10 for retrofitting to a QWERTY keyboard 12 is shown. The interface 10 has a plurality of jumbo buttons 14, 16, 18, 20 fitted onto a base 25 such that each jumbo button 14, 16, 18, 20 covers more than one key 22 of the QWERTY keyboard 12. It is a particular feature of the present invention is that a small number of jumbo buttons 14 (16, 18, 20), in this case merely four buttons, are provided in a simplified interface 10 that serves as a keyboard that is easily operated by infants or the disabled.

The present invention teaches away from U.S. Pat. No. 5,348,405 and Canadian Patent No. 2,194,317 to Fisher Price which describe multi-button covers, in that the multi-button thereof is a depression inhibitor, designed to prevent buttons from being pressed, whereas in contradistinction to the present invention as disclosed herein, keys on the computer keyboard are coupled together as jumbo buttons.

The plurality of jumbo buttons 14 (16, 18, 20) may be brightly colored and may be marked with easily recognized symbols such as letters, numbers, shapes and icons. A base plate 42 of the interface 10 is provided. This may shield the other keys of keyboard 12 preventing their being accidentally depressed. Alternatively, these other keys may programmed (or deprogrammed), so as not to respond to depressions

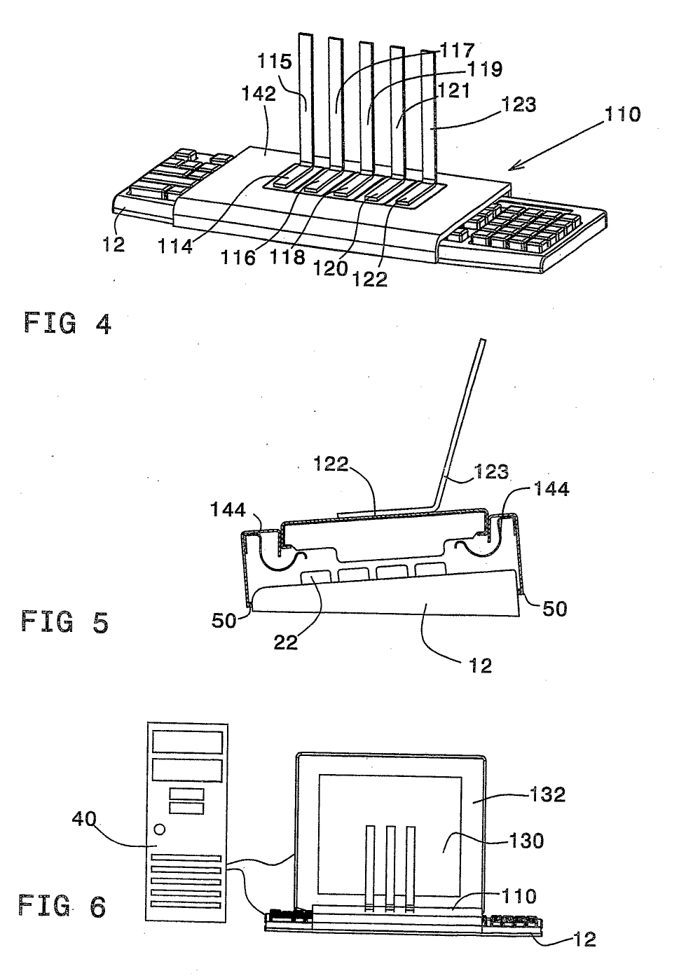

Referring to FIGS. 4 to 6, in an interface 110 according to a second embodiment, vertical push levers 115, 117, 119, 121, 123 are coupled to jumbo buttons 114, 116, 118, 120, 122 for registering keystrokes on the keys 22 under the jumbo buttons 122 (FIG. 5) by pushing or pulling the vertical push levers 123 (115, 117, 119, 121). Although vertical push levers 123 (115, 117, 119, 121) may be colored or shaped or decorated with pictures or otherwise marked, preferably, as shown in FIG. 6, vertical push levers 123 (115, 117, 119, 121) are transparent and may be aligned in front of a display 130 so that a user can activate the vertical push levers 123 (115, 117, 119, 121) when responding to images on the display 130. The display 130 will typically be displayed on a monitor 132 coupled to the computer 40 to which the keyboard 12 is coupled.

The base 10 (110) has a base plate 42 (142) that covers keys on keyboard 12, typically preventing them from being depressed. The jumbo buttons 14 (114) typically have a spring mechanism 44 (144) that facilitates their retraction to their raised position. Each jumbo button 14 (114) covers more than one key 22 on the keyboard 12.

Keyboards 12 for computers are very similar but the different models do vary somewhat. An interface of the present invention will typically line up each jumbo button thereof with an array of keys therebeneath. Optionally a larger array of keys therebeneath are programmed to respond in the same way, so that all keys actually under the jumbo button may be depressed by depression on the jumbo button thereover, with other keys therearound being programmed to respond in the same way, but being protected from depression by the base plate of the interface thereover. Alternatively, once an interface of the invention is affixed to the keyboard, the keys under the buttons may be programmed in response to a configuration procedure performed by the operator pushing on the jumbo buttons. For example, this may be achieved by a child depressing the buttons in accordance with instructions provided on the screen or via a speech synthesizer of the computer to which the keyboard is attached.

The present invention also relates to a program for programming a QWERTY keyboard such that the more than one key 22 of the QWERTY keyboard 12 interfaced by a specific jumbo button 14 (114) of the interface 10 (110) are programmed in parallel so that any of the keys covered by the same jumbo button 14 (114) will provide an identical signal to the computer 40.

The software program may define a low sensitivity to key strokes, such that only conscious thumping of a jumbo button 14 (114) on the interface will register an input and only one single input is registered per thump.

Although described hereinabove with regard to a keyboard and software program for a child, the invention described herein may be embodied for users with various disabilities.

The number of jumbo buttons may vary considerably between embodiments. For example the first embodiment as shown has four jumbo buttons and the second embodiment has five jumbo buttons. The interface 10 (110) typically includes fixing means 50, such as simple clips, elasticated bands or string for attaching and holding the interface 10 (110) to the keyboard 12.

In preferred embodiments, the interface may fully cover the keyboard and its surrounds, providing a large degree of protection thereto, from spillages and the like. In other embodiments the interface covers only part of the keyboard.

Optionally, the interface may be placed randomly over the keyboard and is self-calibrating in that depressing a jumbo button, alerts the software as to which keys of the keyboard are lying there-under. The underlying keys under each jumbo button are treated equivalently and assigned the functionality of the jumbo button. The affect of depressing keys that are not under any jumbo button may be nullified by the software. This is particularly useful, if the interface transmits forces through sections not designated as keys, such as if fabricated from a relatively soft or flexible material such as Styrofoam, cardboard, a flexible matting material and the like.

The shape and structure of the interface, buttons and fixing means may vary considerably between embodiments. Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. An interface for retrofitting to a keyboard, said interface for covering said keyboard and having a plurality of jumbo buttons, each jumbo button for covering more than one key of the keyboard wherein the interface comprises a material that is relatively soft and flexible compared to materials of jumbo buttons and keyboard.

2. The interface of claim 1, wherein said keyboard comprises at least a QWERTY keyboard.

3. The interface of claim 1 wherein the plurality of jumbo buttons are brightly colored.

4. The interface of claim 1 wherein the plurality of jumbo buttons is marked with easily recognized symbols.

5. The interface of claim 4 wherein the easily recognized symbols are selected from the list of letters, numbers, shapes and icons.

6. The interface of claim 1 wherein each of said jumbo buttons of the plurality of jumbo keys has a different shape.

7. The interface of claim 1 having substantially vertical push levers coupled to said jumbo buttons, for registering keystrokes on the keys under the jumbo buttons by pushing or pulling the vertical push levers.

8. The interface of claim 7 wherein the substantially vertical push levers are transparent and may be aligned in front of a display so that user activates said vertical push levers when responding to the display.

9. The interface of claim 8 wherein said display is displayed on a monitor coupled to the computer.

10. The interface of claim 1, comprising a cover that covers the keyboard, grouping at least a first plurality of keys into at least one jumbo key such as pressure on any of said plurality of keys has an equivalent effect.

11. The interface of claim 10, wherein said cover prevents pressure from being applied to one or more keys of the keyboard, preventing the one or more keys from being depressed.

12. A program for programming a computer keyboard such that the more than one key of the computer keyboard interfaced by a specific jumbo button of the interface of claim 1 are programmed in parallel so that any of said keys, covered by the jumbo button will provide an identical signal to the computer.

13. The software program of claim 12 wherein the software program defines a low sensitivity to key strokes, such that only conscious thumping of a jumbo button on the interface will register an input and only one single input is registered per thump.

14. The software program of claim 12 wherein the computer keyboard is a QWERTY keyboard.

15. The software program of claim 12 wherein keys not associated with the specific jumbo button of the interface are disabled, such that pressure thereon has no effect on the computer.

16. The interface of claim 10, wherein keys of the keyboard not associated with the at least one jumbo button are disabled by a software program such that pressure thereon is not registered by the computer.
